(19) United States
(12) Patent Application Publication
(10) Pub. No.: US 2008/0179478 A1
(43) Pub. Date: Jul. 31, 2008

(54) ADAPTOR FOR VEHICLE MOUNTS

(76) Inventor: Michael Lee, Winter Garden, FL (US)

Correspondence Address: GRAY ROBINSON, P.A., P.O. Box 2328, FT. LAUDERDALE, FL, 33303-9998, US

(21) Appl. No.: 12/045,730

(22) Filed: Mar. 11, 2008

Related U.S. Application Data
(63) Continuation-in-part of application No. 29/261,405, filed on Jun. 12, 2006, now Pat. No. D566648.

(51) Int. Cl. F16M 11/00

(52) U.S. Cl. 248/276.1

(57) ABSTRACT

An adaptor for securing portable devices to mounts used in vehicles such as motorcycles comprises a top wall, a bottom wall, opposed end walls and opposed side walls each having a lower portion that projects outwardly from the bottom wall and is formed with a channel extending from one end wall to the other. A support plate of the vehicle mount slides into these channels, and a spring-biased pin carried by the bottom wall of the adaptor secures the adaptor in place onto the vehicle mount by extending into a locking bore formed in the support plate of such mount.

### FIELD OF THE INVENTION

This invention relates to vehicle mounts, and, more particularly, to an adaptor that allows a number of different portable devices to be mounted to the same vehicle mount.

### BACKGROUND OF THE INVENTION

Motorcycles, snowmobiles, personal watercraft, all-terrain vehicles and the like have become increasingly popular in recent years. Owners of these vehicles have demanded increased accessibility and improved ease of use for accessory items such as global positioning devices (GPS), radar detectors, toll transponders, cell phones, radios, cameras, change holders, garage door openers, personal digital assistants (PDA) and other portable devices. In response to this demand, a variety of mounts have been developed for securing portable devices in an easily accessible location on such vehicles, including control mounts, stem mounts, handlebar mounts, mirror mounts, fairing mounts, specialty mounts and others.

Mounts of the type noted above are secured to different locations on a vehicle, depending on the preference of the rider and on the type of vehicle he or she has purchased. Generally, each mount comprises a support plate that receives and secures the portable device in place, and a base portion connected to the support plate. In motorcycles, for example, the base portion may be connected to the handlebar, to the handlebar control clamps, to an opening at the top of the steering stem, to unused mirror mounting holes, to the top of the fork tube and at other locations.

One disadvantage with mounts of the type described above is their lack of adaptability to different types of portable devices, and portable devices sold by different manufacturers. Typically, the support plate of the mount is formed with a number of mounting holes that are arrayed to align with the mounting structure of a particular portable device, or some type of bracket to engage the device. In either case, the size and location of the mounting holes or bracket(s) are usually designed for one type of device or for the devices of a particular manufacturer, and cannot be safely used with other devices. It is important the any portable device be securely fastened onto a vehicle mount to avoid it detaching from the mount while the vehicle is in use, and attempts to use mounts for certain types of portable devices can be unsafe. If a given mount will not work for certain devices, the owner of the vehicle may be forced to purchase different mounts for his or her portable devices and/or be restricted as to which devices may be transported on the vehicle with one particular mount.

### SUMMARY OF THE INVENTION

The adaptor of this invention is intended for use with a wide variety of vehicle mounts to expand the number of portable devices that may be accommodated by a given mount.

In the presently preferred embodiment, the adaptor comprises a top wall, a bottom wall, opposed side walls and opposed end walls that are interconnected to one another. A lower portion of the side walls projects outwardly from the bottom wall and is formed with a channel extending from one end wall to the other. A support plate of the vehicle mount slides into these channels, and a spring-biased pin carried by the bottom wall of the adaptor secures the adaptor in place onto the mount by extending into a locking bore formed in its support plate.

In the presently preferred embodiment, the top and bottom walls of the adaptor have an array of aligning mounting holes that are positioned and sized to receive mounting structure, such as threaded studs, from a number of different types and models of portable devices. One group of mounting holes in the array may mate with the mounting structure of one portable device, whereas another group may accommodate one or more other devices. The portable device is secured to the adaptor first, and then the adaptor is affixed to the top plate of the mount, as discussed above.

The adaptor of this invention significantly enhances the adaptability of vehicle mounts to different types and models of portable devices. In the event the existing array of mounting holes in the support plate of the mount does not align with the mounting structure of a particular device, the adaptor of this invention may be quickly and easily connected to such portable device and then secured onto the mount. Further, the adaptor is easily removed from the mount by urging the pin out of engagement with the locking bore in the support plate thus allowing the adaptor to slide out of contact with the support plate and disengage the vehicle mount.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a bottom, perspective view of the adaptor of this invention;

FIG. 2 is a top, perspective view of the adaptor depicted in FIG. 1;

FIG. 3 is a perspective view of the mount of FIGS. 1 and 2 in the process of being secured to one type of vehicle mount, e.g. a stem mount for a motorcycle in this illustration; and

FIG. 4 is a view similar to FIG. 3 except with the adaptor in a seated position and a handlebar mount depicted.

### DETAILED DESCRIPTION OF THE INVENTION

Referring now to the Figs., the adaptor 10 of this invention comprises a top wall 12, a bottom wall 14, opposed side walls 16 and 18, and, opposed end walls 20 and 22. The side wall 16 has a lower portion 24 that projects outwardly from the bottom wall 14, and the side wall 18 has a similar lower portion 26. The lower portions 24 and 26 are formed with channels 28 and 30, respectively, each of which extends between the end walls 20, 22. A stop 32 extends from the bottom wall 14 toward the top wall 12 generally flush with the end wall 20. For purposes of the present discussion, the terms “top,” “bottom,” “upper,” “lower” and the like refer to the orientation of the actuator 10 as viewed in FIG. 2.

In the presently preferred embodiment, a bore 34 is formed in the bottom wall 14 within which a pin 36 is axially movable, i.e. in a direction toward and away from the top wall 12. The pin 36 is connected to one end of a coil spring 38 whose opposite end mounts to the underside of the top wall 10. The pin 36 is movable between an extended position depicted in FIG. 2 in which it projects outwardly from the bottom wall 14, and a retracted position wherein the pin 36 is substantially flush with the bottom wall 14. The spring 38 exerts a spring force on the pin 36 urging it to the extended position, except as discussed below.

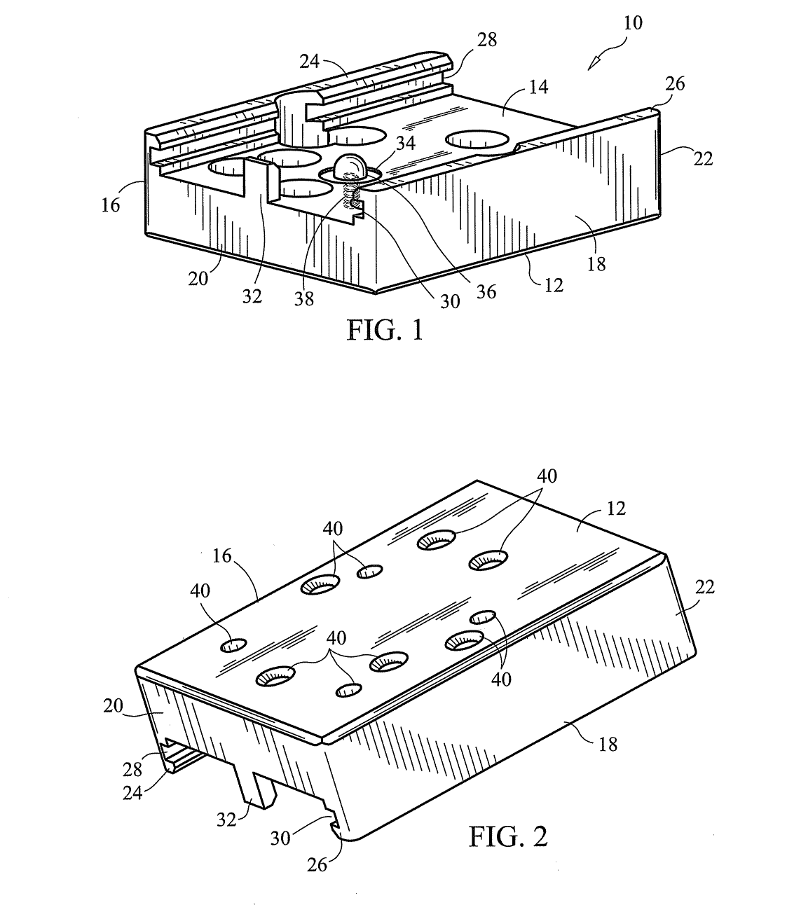

The top wall 12 is formed with an array of mounting holes 40 that also extend through the bottom wall 14. These mounting holes 40 are sized and spatially arranged along the top wall 12 to align with the mounting structure, e.g. threaded studs or the like, of accessory items such as global positioning devices (GPS), radar detectors, toll transponders, cell phones, radios, cameras, change holders, garage door openers, personal digital assistants (PDA) and other portable devices. As seen in FIG. 1, one or more the mounting holes 40 may extend through the channels 28 or 30 in respective lower portions 24, 26 of the side walls 16 and 18.

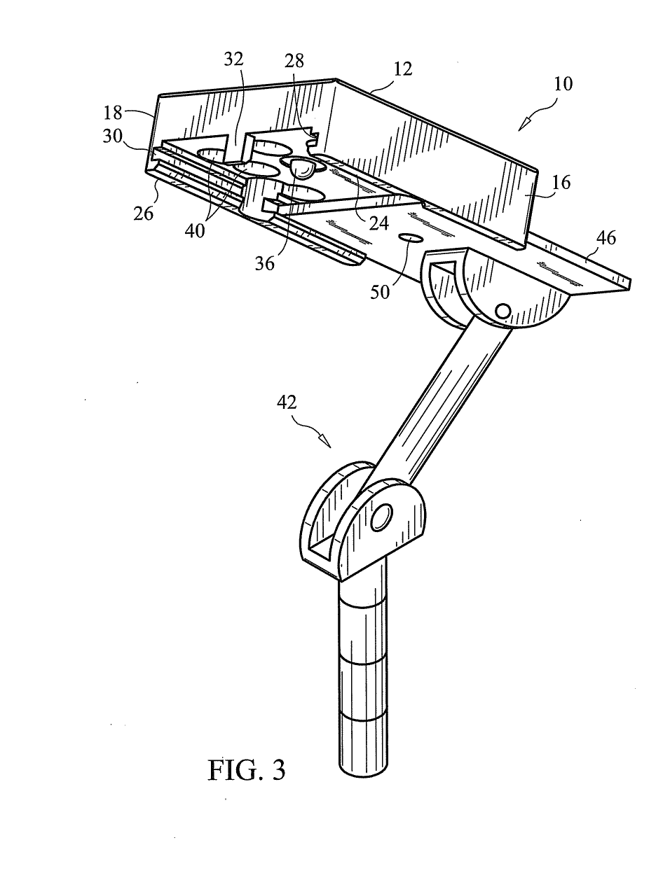

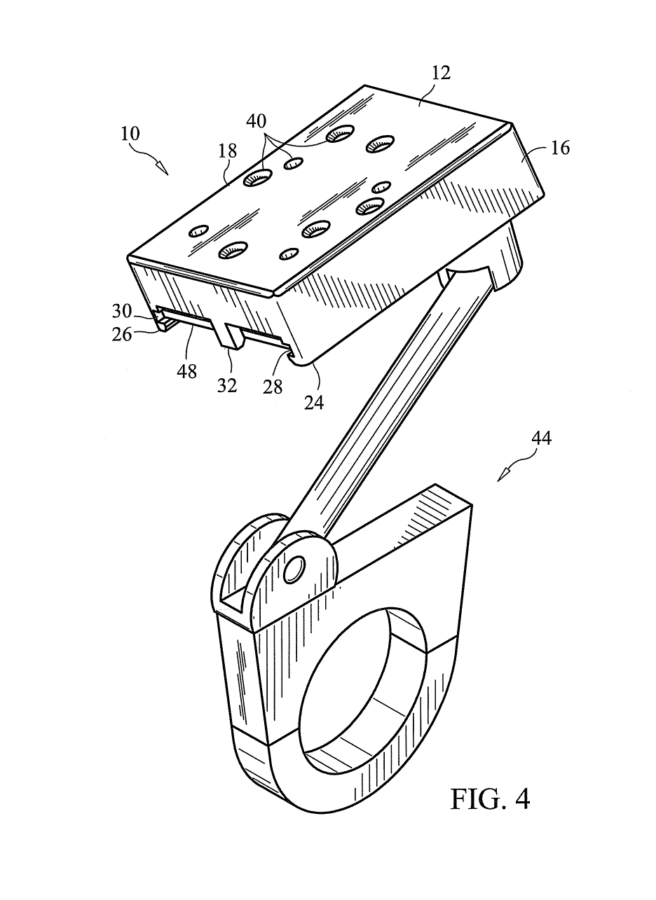

Referring now to FIGS. 3 and 4, two types of mounts 42 and 44 are schematically depicted which may be utilized with vehicles such as motorcycles, snowmobiles, personal watercraft, all-terrain vehicles and the like. The mount 42 is a stem mount intended to connect to the stem of a motorcycle, for example, and the mount 44 is a handlebar mount. The details of these mounts 42, 44 do not form a part of this invention and are therefore not described herein. For purposes of the present discussion, each mount 42, 44 includes a support plate 46 and 48, respectively, that may be formed with a particular array of mounting holes (not shown) for securing the accessory items mentioned above to a vehicle. The actuator 10 of this invention functions to make the mounts 42, 44 more universal in application, i.e. to allow them to be used with a wider variety of accessory items, and/or accessory items made by different manufacturers.

In the event the mounting holes in the support plate 46, 48 of the respective mounts 42 or 44 do not match the threaded studs or other mounting structure of a particular portable device, the adaptor 10 of this invention may be installed on the mounts 42 or 44. Initially, an portable device is attached to the adaptor 10 by placing it onto the top wall 12 and then tightening nuts or the like onto the threaded studs (not shown) of the device that protrude through the holes 40 in the bottom wall 14. The channels 28, 30 of the lower portions 24, 26 of side walls 14, 16 are then aligned with the side edges of the support plate 46 of stem mount 42, for example, and the adaptor 10 is slid along such plate 46. See FIG. 3. In the course of such movement, the pin 36 contacts the support plate 46 and is retracted into the bore 34 against the force of spring 38, in a position substantially flush with the bottom wall 14 of the adaptor 10. Relative movement of the adaptor 10 and support plate 46 continues until the support plate 46 engages the stop 32. In this position, the pin 36 aligns with a locking bore 50 formed in the support plate 46. The pin 36 is moved to its extended position, into the locking bore 50, under the influence of the spring 38 thus releasably connecting the adaptor 10 and support plate 46 together. FIG. 4 depicts the adaptor 10 in the fully seated position on the support plate 48 of the handlebar mount 44, for purposes of illustration. In order to disengage the adaptor 10 from either of the mounts 42 or 44, a small tool such as a screwdriver may be inserted into the bore 34 from beneath the support plate 46 or 48 to retract the pin 36 into its bore 34 and thus allow the adaptor 10 to slide off of such plates 46, 48.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof.

For example, only a stem mount 42 and a handlebar mount 44 are shown in the Figs. However, it is contemplated that the adaptor 10 of this invention may be employed with essentially any vehicle mount used to transport portable items of the type described above. The term “vehicle mount” is intended to be broadly construed and applies to vehicles of essentially any type for land and marine use. Additionally, the particular array of mounting holes 40 formed in the top wall 12 of adaptor 10 is not intended to be exhaustive of the sizing and/or positioning of such holes 40, and variations are considered within the scope of the present invention.

Therefore, it is intended that the invention not be limited to the particular embodiment disclosed as the best mode contemplated for carrying out this invention, but that the invention will include all embodiments falling within the scope of the appended claims.

What is claimed is:

1. Apparatus for mounting portable devices to a vehicle mount having a support plate, comprising:
a top wall, a bottom wall, opposed side walls and opposed end walls interconnected to one another;
said top wall and said bottom wall being formed with an array of aligning mounting holes, said top wall being adapted to mount a device having mounting structure received with said mounting holes;
each of said side walls having a lower portion that projects outwardly from said bottom wall, said lower portions each being formed with a channel extending between said end walls, said channels being adapted to receive the support plate of the vehicle mount; and
a pin axially movable within a bore formed in said bottom wall between an extended position and a retracted position, said pin engaging a spring which urges said pin to said extended position, said pin being adapted to move to said retracted position upon contact with the support plate of the vehicle mount and then move to said extended position within a locking bore formed in the support plate.

2. The apparatus of claim 1 further including a stop mounted to one of said end walls in position to contact the sup port plate of the vehicle mount.

3. The apparatus of claim 1 in which said array of mounting holes are sized and spatially oriented along said top and bottom walls so as to be adapted to receive mounting structure of a variety of different portable devices.

4. Apparatus for supporting portable devices on a vehicle comprising:
a vehicle mount including a support plate formed with a locking bore;
an adaptor releasably coupled to said vehicle mount, said adaptor including:
(i) a top wall, a bottom wall, opposed side walls and opposed end walls interconnected to one another;
(ii) said top wall and said bottom wall being formed with an array of aligning mounting holes, said top wall being adapted to mount a device having mounting structure received with said mounting holes;
(iii) each of said side walls having a lower portion that projects outwardly from said bottom wall, said lower portions each being formed with a channel extending between said end walls, said support plate of said vehicle mount being slidable within said channels;
(iv) a pin axially movable within a bore formed in said bottom wall between an extended position and a retracted position, said pin engaging a spring which exerts a spring force against said pin urging it to said extended position, said pin contacting said support plate and moving to said retracted position against said spring force in the course of sliding said support plate along said channels, said pin moving to an extended position into said locking bore upon alignment of said pin with said locking bore to releasably secure said adaptor to said vehicle mount.

5. The apparatus of claim 4 further including a stop mounted to one of said end walls of said adaptor in position to contact said support plate of said vehicle mount.

6. The apparatus of claim 1 in which said array of mounting holes are sized and spatially oriented along said top and bottom walls so as to be adapted to receive mounting structure of a variety of different portable devices.
